(19) United States
(12) Patent Application Publication
(10) Pub. No.: US 2026/0053692 A1
(43) Pub. Date: Feb. 26, 2026

(54) POWERED WALKING ASSISTANCE DEVICE WITH CANE PORTION USED AS JOYSTICK CONTROLLER

(71) Applicant: James L. King, Bella Vista, AR (US)

(72) Inventor: James L. King, Bella Vista, AR (US)

(21) Appl. No.: 18/814,495

(22) Filed: Aug. 24, 2024

(51) Int. Cl. A61H 3/04; A61H 3/02

(52) U.S. Cl. CPC A61H 3/04; A61H 3/02; A61H 2003/043

(57) ABSTRACT

An electronic walking assistance device, comprised of a cane or related medical mobility device portion, having a surface(s) for supporting the user's arm(s) and/or hand(s), and a self-leveling electromotive device platform, which automatically creates motion to follow the movement of the user, enabling walking assistance that maintains constant contact with the surface under foot, without lifting the device off the ground.

### CROSS REFERENCE TO RELATED APPLICATION

This application claims the benefit of, and is a continuation-in-part of, the prior U.S. Nonprovisional application Ser. No. 16/999,502 filed Aug. 21, 2020.

### TECHNICAL FIELD

The present invention relates to mobility and walking assistance devices.

### BACKGROUND OF THE INVENTION

There are different kinds of walking assist devices, including walking canes, walking staffs, walkers, and crutches.

A conventional walking assist device has a flat bottom, and a user presses that flat bottom against the ground and uses the stable support provided by the flat bottom, to walk next to the support.

### SUMMARY OF THE INVENTION

The inventor recognized, however, that there are a number of drawbacks with the current systems.

An embodiment describes a power assisted walking device, referred to in embodiments as a “cane”, which includes a walking cane, walking staff, an underarm crutch, a horizontal forearm crutch, a walker, or any other walking assistance device.

An embodiment describes a walking assistance device with an electromotive device that automatically follows the user's movements, without the device lifting off the ground.

### BRIEF DESCRIPTION OF THE DRAWINGS

For a better understanding of the present invention including the features, advantages and specific embodiments, reference is made to the following detailed description along with accompanying Figures.

FIG. 1 shows a first embodiment where the walking assistance device is a walking cane/walking staff;

FIG. 2 shows the tactile joystick controller connection that forms an interface between the walking cane and the electromotive device;

FIG. 3 shows an embodiment where the walking assistance device is an underarm crutch;

FIG. 4 shows an embodiment where the walking assistance device is a horizontal forearm crutch;

FIG. 5 shows an embodiment where the walking assistance device is a walker;

FIG. 6 shows an embodiment where the walking assistance device is a walking staff;

FIG. 7 shows a wiring harness attachment between the handle switch and an adjustable height bottom;

FIG. 8 shows the wiring harness used inside the cane; and

FIG. 9 shows an end view of the electromotive device in one embodiment of the present invention.

### DETAILED DESCRIPTION

An embodiment describes a walking assistance device which uses an electromotive device that responds to direction of user movements as a powered walking assistance. In an embodiment, the electromotive device uses a self-leveling feature which detects the direction of the user's leaning in order to provide motive force in that direction. Leaning forward typically causing the device to go forward, standing up straight up allows coasting and slightly leaning backwards provides a braking action.

According to embodiments, a walking assistance device uses the cane portion of the walking assistance device as a joystick, referred to herein as a tactile control joystick, to control a powered device by tilting the tactile control joystick in place of the normal leaning done by the operator of the self-leveling electromotive device. The tilting of the tactile joystick controller becomes the controller to cause the self-leveling electromotive device to be powered on; and the degree of tilt regulates the increase in speed of the self-leveling electromotive device.

In an embodiment, where the device is shadowing the movement of the person, the device is used by holding the hand and forearm stationary with respect to the body. When the body moves forward, backs up or turns, the tilting action of the cane/staff automatically tilts the self-leveling feature of the or self-leveling electromotive device, causing movement to a position where the device is levelled.

The walking assistance device also follows a user when the user turns. The user holds their hand stationary with respect to the body. When the user turns, this automatically turns the cane handle. The handle is linked to the self-leveling electromotive device mechanically through the staff. The whole system turns together, mechanically following the user, using the handle as a joystick.

An embodiment may include additional steering linkage. A major advantage of a self-leveling electromotive device is that its wheel separation provides the user significant lateral stability. The action of turning the handle acts through the steering mechanism to change the level of the upper surface, to appropriately energize the motors. If the body is just moving forward or backwards, this only tilts the staff backwards or forwards, which causes the self-leveling feature of the hoverboard to energize the motors equally. This causes the self-leveling electromotive device to only move forward or backward in a straight line, following the user's motion.

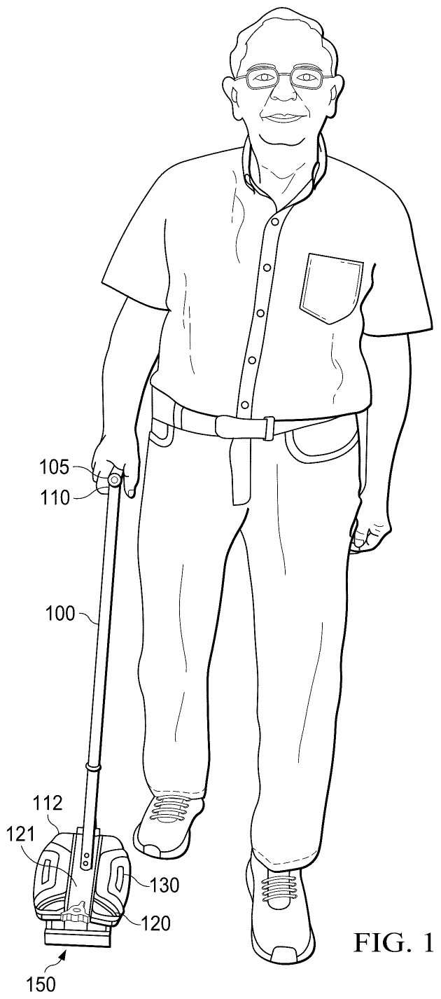

Multiple embodiments are described herein, each using a walking cane type device, attached by a joystick connection, a tactile control joystick, connected to an electromotive device of a type which responds to direction of force on a surface. An embodiment is shown in FIG. 1, providing an embodiment used as a walking cane 100.

Most walking assistance devices have an adjustable height. For example, in a standard walking cane, there is a lower round tubular section that has a snap pin inside that protrudes through a single hole in the cane's lower section. The hole is located approximately ¼ of the distance up from the bottom of the cane. The pin is retained by a U-shaped spring that fits inside the lower section. The U-shaped pin holds the spring securely in the hole. The spring force is such that a person's index finger can depress the snap pin and allow raising or lowering the cane length.

The upper portion of the cane's inside diameter is sized to be a slip fit over the lower portion of the cane to move up and down.

To change the height of the handle, the snap pin in the lower section of the cane is depressed and the upper portion of the cane is rotated slightly. This slight rotation prevents the snap pin from locking into the next adjacent hole in the upper portion of the cane. The upper portion is then slid to the desired handle height. The closest hole in the upper portion of the cane is then aligned with the snap pin. The upper portion is locked to the desired handle height by the action of the snap pin interlocking with the hole in the upper cane portion.

A control, for example, on off switch 110, is located in or near the handle of the cane, to be operated, for example, by the index finger of the user. The electromotive device 120 is controlled by the on off switch. The electromotive device 120 responds to movement of the handle to move in the direction of the force applied to the top surface 121 of the electromotive device 120.

The electromotive device 120 is connected by a staff mount 130 to the bottom portion 112 of the cane. In operation, the top portion 105 of the cane, where the user holds the cane, forms a tactile control joystick staff, which enables instigating the electromotive device 120 to move forwards, backwards, and side to side, and to enhance steering. This causes the power unit, and hence the cane, to follow the user's movements.

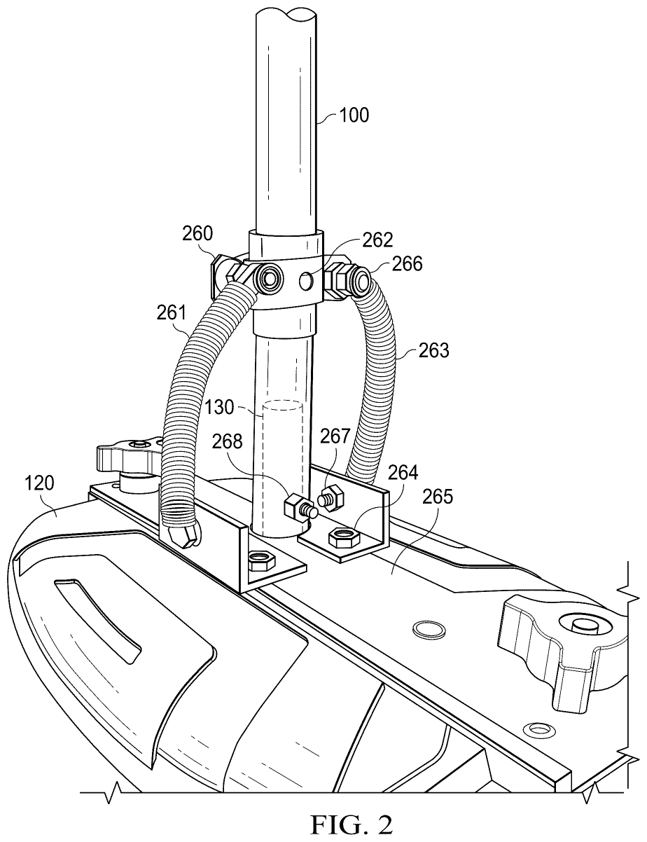

The tactile joystick connection 130 is shown in further detail in FIG. 2.

The tactile joystick connection 130, shown in FIG. 2 allows tilting of ±10 degrees side to side on the pivot shaft 268. The top portion of the joystick connection 130 is connected to the cane 100. The bottom portion of the joystick connection 130 is connected to the electromotive device 120. The cane or other medical mobility devices 100 ends at an extension spring assembly 260 which includes first and second extension springs.

The first extension spring 261 is connected between a first bracket 262 that is attached to the cane, and a second bracket 265 that is attached to the electromotive device 120. The bracket 262 also includes a second extension spring 263 attached to an opposite side bracket 264. Each of the extension springs 261 and 263 are straight extension springs approximately 4 inches long, with both ends of the expansion springs restrained by nuts and bolts. The nuts and bolts such as 266, 267, 268 hold the extension springs stationary when locked by lock nuts. This prevents the spring loops from rotating. Pivot Shaft 268 allows the unit to tilt plus and minus 10° side to side on the bolt axle, but not to rotate, and not to pivot forward or backward.

The bent straight springs allow assistance with the steering of the electromotive device 120 using the tilting tactile joystick staff (“TTJS”) operation. As the joystick tilts towards one spring, the tension in that one spring increases and the opposite spring tension decreases. The TTJS Pivot Shaft 268 at the base of the staff allows the staff to tilt side to side but be rigid in a forward and backwards direction. This allows a self-centering operation where the tactile control joystick staff always returns to a neutral 90 degree vertical position. This side to side tilting ability of the tactile control joystick staff and being rigid forward and backwards allows the tactile control joystick staff to tilt side to side with respect to the base until and still simultaneously control the forward and backwards force on the tactile control joystick thereby controlling the speed of the power unit.

The operation of following the user's movements occurs by holding the handle stationary relative to the body. Any movement of the body is transferred to the tactile control joystick staff 130 and the electromotive device 120 then senses that movement and automatically follows the user's motion. However, up to 10 degrees of side to side movement is absorbed by the springs, thus preventing the electromotive device (also referred to as the power unit) from turning unless more than 10 degrees of side to side force is applied.

In an embodiment, there are parking stands 150 with bumper bars at front and back to prevent the device from running into something and causing damage. The front bumper bar has two charging terminals enabling charging of the device.

The back bumper bars are for impact resistance. Both bumper bars also operate for parking. In addition, in one embodiment, the bumper bars can be illuminated with LED lights that shine through the bumper bars. The bars can create a stable platform to assist with sitting or standing.

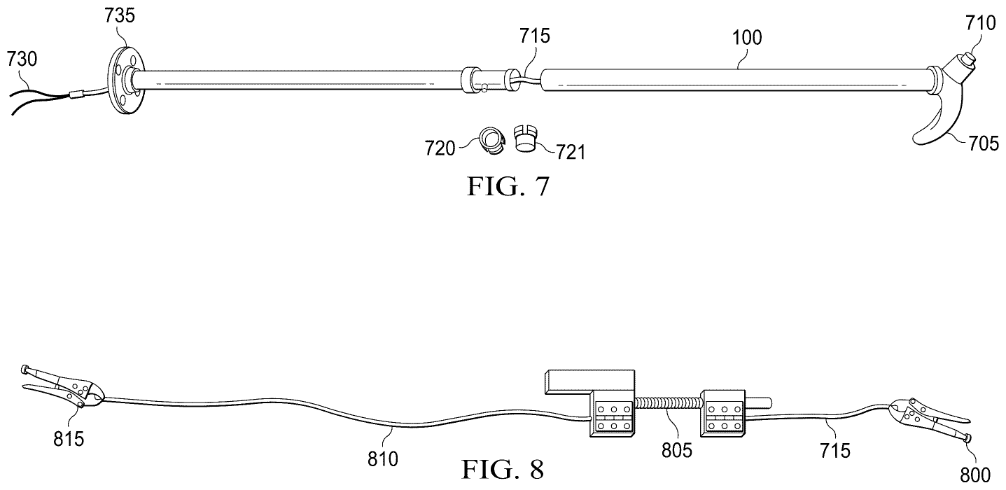

In addition, since the cane part is adjustable in height, a height adjustment wire adaption device is used as described herein with reference to FIG. 7. The height adjustment wire device is located inside cane 100, and is described with further detail with relative to FIG. 7.

The walking assistance device in another embodiment can be a walking staff, and the cane includes a single pole with a lower horizontal handle and vertical ergonomically tilted handle.

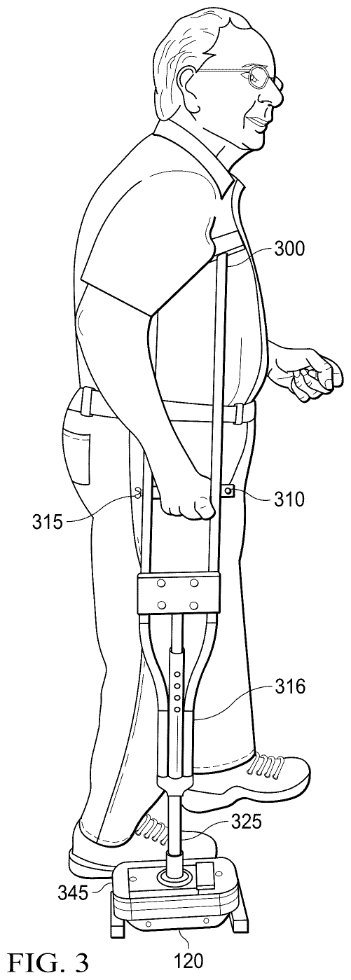

FIG. 3 shows an embodiment where the system is applied to an underarm crutch. As with the other embodiments, the underarm crutch uses a tactile joystick staff for causing the self levelling power unit 120 to follow the user's movements. The underarm crutch 300 is located beneath an underarm of the user, as conventional. The user then holds onto grip handle 315 with their hand. The grip handle 315 is generally at the center of the crutch device.

The on-off switch 310 is located near the user's hand position, for example on the outside of the crutch at the end of the center grip handle 315.

A height adjustment part 316 uses a snap pin system as described above to adjust the height. The bottom part of the crutch 325 connects to the self-leveling power unit 120 via the tilting tactile joystick staff connection, shown in FIG. 2.

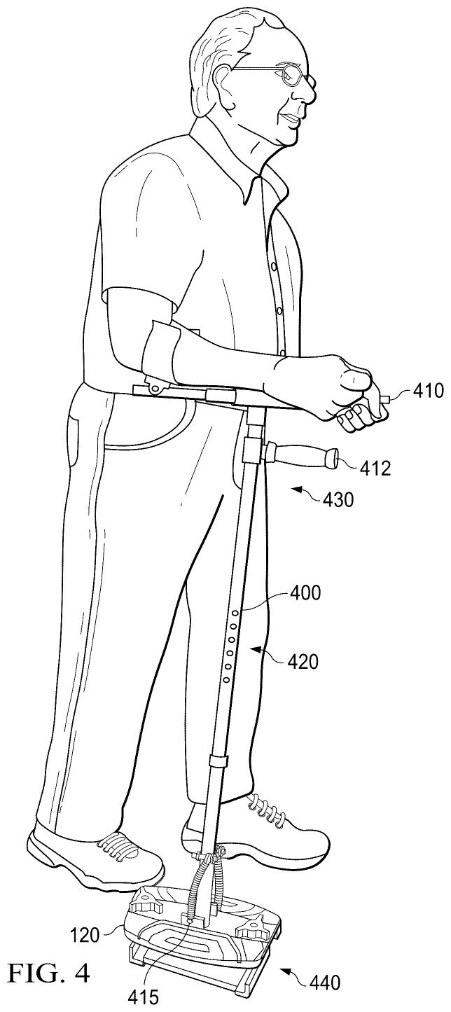

FIG. 4 shows a modified device where the cane 100 is a horizontal forearm crutch 400. The on-off switch is located on handle 410. An adjustable height pin locking system 420 allows changing the height of the crutch staff 400 to fit properly to a user's height. The distal end 430 of the crutch staff 400 is modified to attach to the top portion of the self-leveling power unit 120, via a tilting tactile joystick staff attachment 415 of the type shown in FIG. 2. This allows the operator to tilt the forearm crutch 10° side to side. It also allows the single motor/wheel to remain in intimate contact with the floor and also enhances the steering. The motive force is provided by the user moving relative to the self levelling platform 120.

In all the embodiments described herein, there can also be add-on devices shown as 412. This can include bicycle add-ons like a bell, cell phone holder, flashlight, rearview mirror, or other bicycle accessories. This can also carry a water bottle holder or small carry bag. The powered add-ons can be battery powered or can be powered via wires attached to the self levelling platform 120.

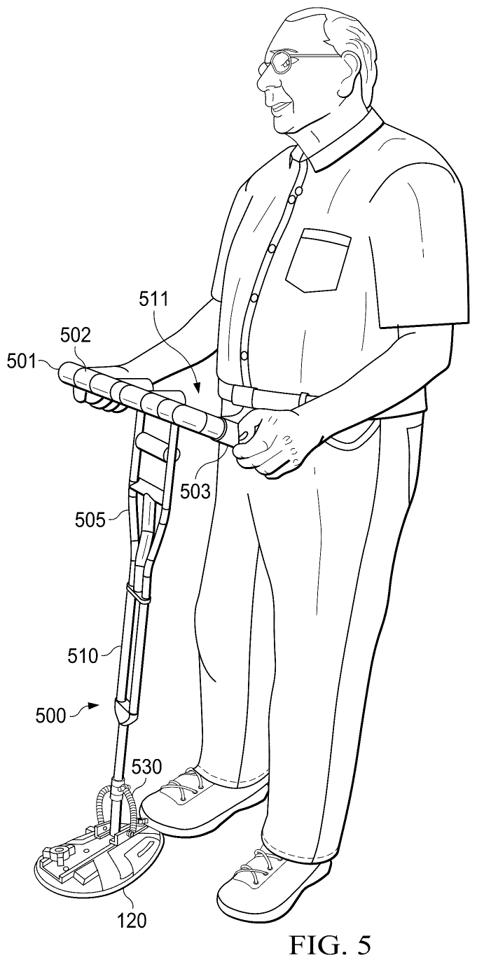

FIG. 5 shows an embodiment where the walking assistance device is a walker 500, where the cane portion 505 is formed by a modified crutch staff 505 of adjustable height that uses a height adjustment mechanism 510. The handles 502 are horizontal handles attached to the top of the crutch staff 505, with a switch 501. In an alternative embodiment, there can be one switch 501 in each side of the handle 502.

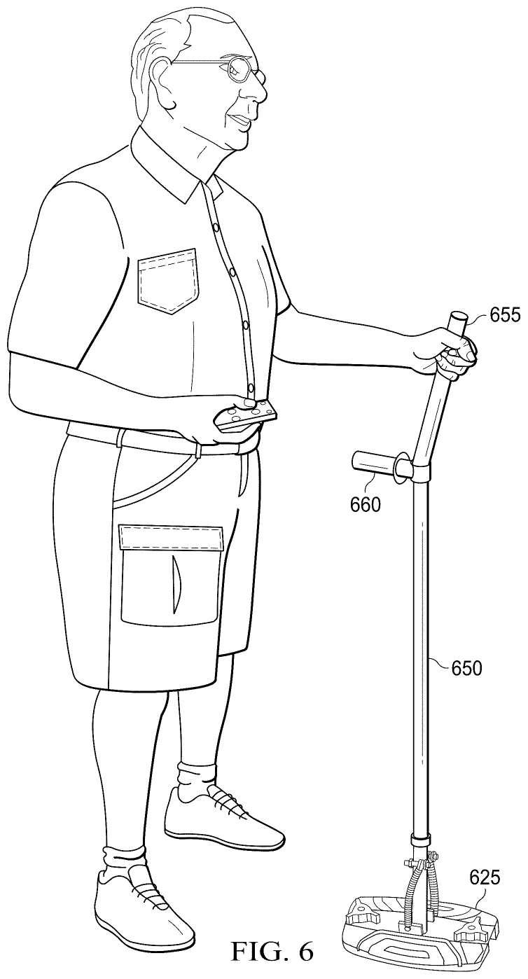

FIG. 6 shows an embodiment where the walking assistance device is a walking staff/trekking staff/hiking pole. The walking staff 650 is attached to the electromotive device 625 via a TTJS connection as in the other embodiments. The walking staff 650 is used in a normal manner as a trekking staff, by holding the top handle 655. When used as a trekking staff, the top handle's 10° tilt is for ergonomic purposes. As shown in FIG. 5, the 10° angle fits the common grasp tilt of a normal hand.

There is also a cane type handle 660 being used to lift the staff with an open hand. This feature allows people with impaired grip issues to lift the staff without gripping.

When used as a trekking staff, top tilted handle 655 is a joystick. The horizontal handle 660 has two uses: lifting—over thresholds and curbs or to obtain motion, used as a joystick.

The second handle can be added in this way to any of the embodiments described herein. There can also be assistive add-ons as in previous embodiments shown as 511. The add-on here is shown as a bell, but this can also be a cell phone holder, flashlight, rearview mirror, video camera, water bottle holder or carry bag. Addition of a water bottle or carry bag will require zeroing the self-leveling aspect of the base.

In the embodiment, the handles 502 are ergonomically tilted downward at the area 503 to make it easier to hold onto the walker. The crutch staff has an adjustable height which is adjusted via an adjustment adjustable height mechanism 510. This connects to the self levelling drive mechanism 120 by a tactile control joystick or TIS or TTJS 530 which is similar to that shown in FIG. 1 as in the other embodiments.

An important feature of the walker is the ability to adjust the height of the walker. However, since this is used as a walking assistance device, it is desirable, or perhaps even necessary, that the on-off switch be in one or both of the handle portion of the cane. However, this means that the electronics from the switch needs to be conducted, via wires, from the upper portion to the self-leveling drive mechanism at the bottom of the device. Typically, this uses a momentary on-off switch, and wire, for example, an 18-gauge wire.

However, the wire that runs from the self-leveling electromotive device to the handle can fold over on itself and can pinch when the upper portion of the cane's handle is height adjusted. If the user performs the normal remedy of pushing down harder on the handle, this jams the wires more firmly together and locks the upper portion in place. This has the effect of preventing the adjustment, since this can pinch the wires.

In this embodiment, the wire used is like a coiled phone wire on a telephone handset. Its purpose is to stretch and retract to keep the handset wire from becoming entangled and to also make the handset wire as short as possible. A two-wire telephone handset coiled wire was used to wire the switch but it has disadvantages: A first disadvantage is that the wire jacket is too large so when the coiled wire is manufactured the diameter of the coil is too large to fit inside a standard cane tube. The telephone wire plastic jacket is not a slippery finish, so it contributes to the coiled wire's tendency to jam.

The plastic jacket of the telephone handset wire is also much larger than is necessary to insulate the conductors low voltage conductors from the metal wall of the cane tube.

According to an embodiment, a solution to the problem is to use a two conductor, 18 gauge silicone plastic, insulated wire, that is coiled. The coils are created by wrapping them in a fixture that has a small diameter (approx. ¼″ diameter) metal rod. The fixture securely holds both coil ends. The coil is wrapped in the center of a length of wire. The number of coil wraps must be controlled to assure the stretched and contracted length is adequate for the application it is to be used in. The unwrapped ends must also be long enough to reach their desired destinations depending on which self-leveling electromotive medical mobility device embodiment they are installed in. The silicon insulated wire prevents the wire from sticking to the inside of the cane tube. A heat gun is used to heat the wire insulation to the point of being plastic, but not melting. The wire is then cooled, e.g., in a refrigerator. This is a preferable cooling method because it assures the wire insulation takes a set and retains its coiled condition.

Most canes have plastic nylon bushings that are inserted into the top end of the lower cane tube. The nylon bushing is used to remove the looseness of the slip fit of the upper and lower cane tubes. The canes are designed to have three to four plastic sections that compress when the lower tube is inserted into the upper tube, In an embodiment, this plastic insert is used as an anchor point for the coiled wire. This anchoring is necessary because the upper cane section is moving away or towards the lower tube section when the cane height is adjusted.

The cane or staff is attached to a removal base. Unplugging the switch control wire and loosening the clamping knobs will allow attachment of the Tactile Control to any self-leveling electromotive device. Other anchoring points can alternatively be used.

The wire that is in the lower portion must be restrained so no force is exerted on the plug connection between the self-leveling electromotive device and the lower cane tube. This restraint is accomplished by tying a simple once over knot in the wire.

The wire is inserted through the nylon plastic insert, which is hollow, and then the wire is routed through the lower tube. After pulling the wire through the lower cane tube section, the plastic insert is installed by pushing it into the top of the lower tube. The upper tube with the coil in it is installed over the nylon bushing and over the lower cane tube. When the handle height is increased the knot (or similar wire restraint) contacts the plastic insert and the coiled wire is forced to be restrained and forced to uncoil without straining any wire connections.

In an embodiment, the upper coil's wire end is restrained by being routed through a 90 degree turn to reach the switch in the handle. If there is no 90-degree turn, then another form of upper wire restraint must be provided.

The self-leveling electromotive medical mobility device Horizontal Forearm Crutch is not a form of crutch that is operable like existing Standard 45° forearm Crutch or a tilted 80°/10° Crutch. The reason is that the current embodiments all require the crutch to be lifted after bearing the weight of the user. In the weight bearing phase, the user moves the body forward. Then the crutch is lifted and advanced and placed on the ground awaiting the next weight bearing phase. The self-leveling electromotive medical mobility device Horizontal Forearm Crutch exists as an assistive walking device, but the forearm must be retained by a strap system. There are two basic reasons: First it would require strapping or restraining the crutch to the elbow end of the forearm. Second, the hand would need to grasp the front of the crutch, or the front of the forearm restrained by straps to the crutch. Both the forearm restraint and grasping the handle are absolutely necessary to pick the crutch up and move it forward.

None of the walking assistance devices of any of the embodiments require lifting off the ground. The self-leveling electromotive medical mobility device Horizontal Forearm Crutch, or self-leveling electromotive medical mobility device 45° forearm Crutch or the self-leveling electromotive medical mobility device Underarm Crutch does not spend any time off the ground. This is possible because the base power unit can carry the full weight of the user 100% of the time. The current existing crutch designs cannot advance and be weight bearing at the same time. The current forearm crutches must have a means to cause the crutch to follow the user's forearm. If it does not follow the user's forearm, then it cannot be advanced. The self-leveling electromotive medical mobility device maintains constant contact with the surface under foot by eliminating the traditional “hopping” associated with using a cane or walker. In addition, the self-leveling electromotive medical mobility device concept follows the users every horizontal body movements.

The self-leveling electromotive medical mobility device concept can be adapted to any forearm crutch on the market. The Staff of any existing crutch can be modified to act as a (TCS) Tactile Control Staff, or (TJS) Tactile Joystick Staff, or (TTJS) Tactile Tilting Joystick Staff to control the powered base unit.

While the above has described a first embodiment using a walking cane, it should be understood that additional embodiments operate similar subject matter in order to provide different kind of walking assistance devices. FIG. 3 for example, shows an underarm crutch. In the underarm crutch, for example, the on-off switch can be located on 310 while the crutches 300 and the switch 310 can be located on the outside of the crutch at the end of the center grip handle 315. The crutch is height adjustable, using a button and hole system 315. This connects to the self-leveling electromotive device 120. The connection provides mounting the crutch staff to the self-leveling platform, SLP.

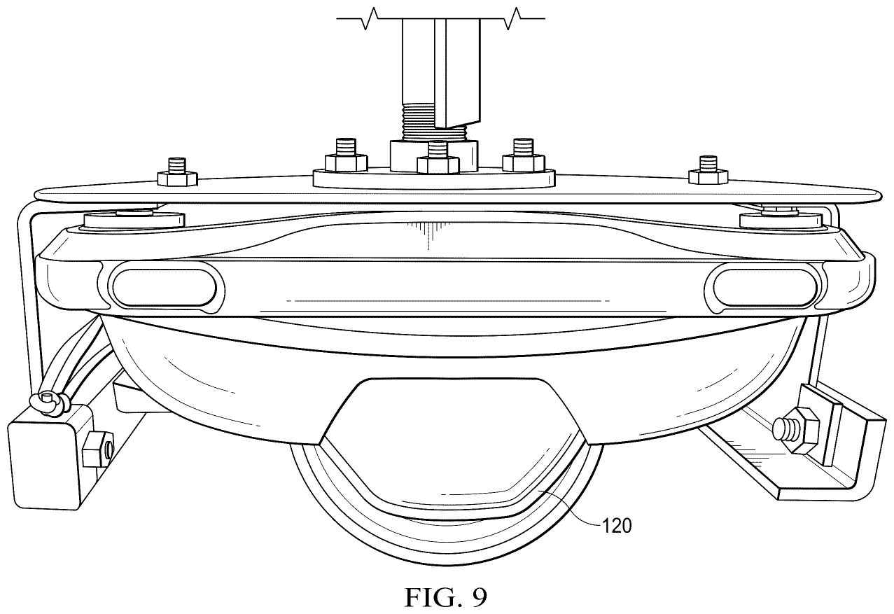

An exploded view of the device is shown in FIG. 7, which shows the exploded view where the cane part is actually a walking cane 100, having handle 705. A switch 710 is placed in the handle, connected via a wire shown as 715. FIG. 8 shows the wiring harness, showing the wire that is placed inside the cane. In an embodiment, this is a coiled wire extension 715 which extends from the switch in the handle, or the wire extension 715 extends to a coiled wire extension 800 which is a coiling fixture with the coiled wire in place. This is located in the upper cane tube. This coiled wire extension then extends from the coiling part 805 via another wire extension to a lower coiled wire extension 815. This is threaded down to the inner the end piece. Nylon bushings 720, 721 are used to reduce looseness between the upper and lower cane tubes. The first coil part 805 is located in the upper part of the cane, and the second coiling part extends through the nylon bushings, ending in the plugged plug-in connectors 730 that connect to the motor of the electromotive device, e.g., self-leveling electromotive device. Note also the self-leveling electromotive device plate 735 which connects the top of the self-leveling electromotive device, enabling the angling of the cane to form a joystick for controlling the self-leveling electromotive device.

In an embodiment, said cane portion comprises at its lower end a single axis hinge connecting the cane portion to the top of the electromotive device allowing the single degree of freedom side to side movement of said cane portion relative to said electromotive device.

The invention is an electronic walking assistance device, comprising a cane portion, having surfaces for holding against arms and/or hands of a user, an electromotive device, which automatically creates motion to follow a movement of the user, enabling walking assistance without lifting the electromotive device off the ground, a tactile joystick connection between the cane portion and the electromotive device, which translates forward and backwards motion by the user into a tilting action against the electromotive device that causes forward or backward movement of the electromotive device, and where the tactile joystick connection allows side to side movement of a specified amount without translating that into movement of the electromotive device said cane portion terminating at an extension spring assembly that has extension springs on the left and right lateral sides that allow the side-to-side movement of the specified amount.

In the invention, the cane portion is used as a joystick to control the electromotive device. Further, the electromotive device has a pressure sensitive surface which moves based on leaning of the cane portion based on the movement of the user. The electromotive device is a self-leveling electromotive device. The tactile joystick connection is operable to allow tilting of up to 10° from vertical to one side and up to 10° from vertical to the other side. A switch is located in the cane near a hand of the user. The height of the cane portion is adjustable. A wire extends from the switch to the electromotive device, wherein the wire is coiled in an area for height adjustment. The walking assistance device is a walking cane, said walking cane comprising a single pole. The walking assistance device is a walking staff, said cane comprising a single pole with a lower horizontal handle and vertical ergonomically tilted handle. In an embodiment, the walking assistance device comprises an underarm crutch. In an embodiment, the walking assistance device comprises a horizontal forearm crutch. In a further embodiment, the walking assistance device comprises a walker.

The invention is an electronic walking assistance device, comprising a cane portion, having surfaces for holding against arms and/or hands of a user, an electromotive device, which automatically creates motion to follow a movement of the user, enabling walking assistance without lifting the electromotive device off the ground, a tactile joystick connection between the cane portion and the electromotive device, which translates forward and backwards motion by the user into a tilting action against the electromotive device that causes forward or backward movement of the electromotive device, and where the tactile joystick connection allows side to side tilting movement of up to 10° from vertical to one side and up to 10% from vertical from the other side without translating that into movement of the electromotive device. The cane portion ends at an extension spring assembly which allows the tilting movement of up to 10° from vertical to one side and tilting movement of up to 10% from vertical from the other side 10° and the cane portion comprises at its lower end a single axis hinge connecting the cane portion to the top of the electromotive device allowing the single degree of freedom side to side movement of said cane portion relative to said electromotive device. An extension spring assembly further comprises extension springs on the left and right sides of said cane portion connecting said cane portion to the top of said electromotive device. The extension spring assembly comprises a flat steel spring connecting said cane portion and the top of said electromotive device. Further, the extension spring assembly comprises a flat plastic spring connecting said cane portion and the top of said electromotive device. The extension spring assembly comprises a coil spring mounted between guide rails connecting said cane portion and the top of said electromotive device. The extension spring assembly comprises a plastic shaft that has a flexible section connecting said cane portion and the top of said electromotive device.

Finally, the invention is an electronic walking assistance device, comprising a cane portion, having surfaces for holding against arms and/or hands of a user, an electromotive device, which automatically creates motion to follow a movement of the user, enabling walking assistance without lifting the electromotive device off the ground, a tactile joystick connection between the cane portion and, the electromotive device, which translates forward and backwards motion by the user into a tilting action against the electromotive device that causes forward or backward movement of the electromotive device, and where the tactile joystick connection allows side to side movement of 10° without translating that into movement of the electromotive device. The cane portion ends at an extension spring assembly which allows the side-to-side movement of up to 20°. The cane portion further comprises at its lower end a single axis hinge connecting the cane portion to the top of the electromotive device allowing the single degree of freedom side to side movement of said cane portion relative to said electromotive device and said electromotive device comprises a self-leveling, battery powered self-leveling electromotive device. The extension spring assembly comprises a first spring between a left side of the second end of the cane and a second spring on the right side of the second end of the cane and the movement device, which allows flexing of the cane in the side-to-side direction but does not allow flexing of the cane relative to the top surface of the movement device in the front to back direction. The cane portion comprises a switch located in the handle near a hand of the user and the cane portion further comprises an adjustable height and a wire, which extends from the switch to the movement device, wherein the wire is coiled in an area of a height adjustment.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

I claim:

1. An electronic walking assistance device, comprising:
a cane portion, having surfaces for holding against arms and/or hands of a user;
an electromotive device which automatically creates motion to follow a movement of the user, enabling walking assistance without lifting the electromotive device off the ground; and
a tactile joystick connection between the cane portion and the electromotive device, which translates forward and backwards motion by the user into a tilting action against the electromotive device that causes forward or backward movement of the electromotive device, and where the tactile joystick connection allows side to side movement of a specified amount without translating that into movement of the electromotive device and wherein said cane portion terminates at an extension spring assembly that has extension springs on the left and right lateral sides that allow the side-to-side movement of the specified amount.

2. The device as in claim 1, wherein the cane portion is used as a joystick to control the electromotive device.

3. The device as in claim 1, wherein the electromotive device has a pressure sensitive surface which moves based on leaning of the cane portion based on the movement of the user.

4. The device as in claim 3 wherein the electromotive device is a self-leveling platform having therein a self-leveling electromotive device.

5. The device as in claim 1 wherein the tactile joystick connection operable to allow tilting of up to 10° from vertical to one side and up to 10° from vertical to the other side.

6. The device as in claim 1 further comprising a switch located in the cane near a hand of the user.

7. The device as in claim 1 wherein a height of the cane portion is adjustable.

8. The device as in claim 7 further comprising a wire which extends from the switch to the electromotive device, wherein the wire is coiled in an area of the height adjustment.

9. The device as in claim 1 wherein the walking assistance device is a walking cane, said walking cane comprising a single pole.

10. The device as in claim 1 wherein the walking assistance device is a walking staff, said cane comprising a single pole with a lower horizontal handle and vertical ergonomically tilted handle.

11. The device as in claim 1 wherein the walking assistance device comprises an underarm crutch.

12. The device as in claim 1 wherein the walking assistance device comprises a horizontal forearm crutch.

13. The device as in claim 1 wherein the walking assistance device comprises a walker.

14. An electronic walking assistance device, comprising:
a cane portion, having surfaces for holding against arms and/or hands of a user;
an electromotive device, which automatically creates motion to follow a movement of the user, enabling walking assistance without lifting the electromotive device off the ground;
a tactile joystick connection between the cane portion and the electromotive device, which translates forward and backwards motion by the user into a tilting action against the electromotive device that causes forward or backward movement of the electromotive device, and where the tactile joystick connection allows side to side tilting movement of up to 10 degrees from vertical to one side and up to 10 degrees from vertical from the other side without translating that into movement of the electromotive device;
said cane portion ends at an extension spring assembly which allows the tilting movement of up to 10 degrees from vertical to one side and tilting movement of up to 10 degrees from vertical from the other side; and
wherein said cane portion comprises at its lower end a single axis hinge connecting the cane portion to the top of the electromotive device allowing the single degree of freedom side to side movement of said cane portion relative to said electromotive device.

15. The device as in claim 14 wherein said extension spring assembly comprises extension springs on the left and right sides of said cane portion connecting said cane portion to the top of said electromotive device.

16. The device as in claim 14 wherein said extension spring assembly comprises one or two flat steel springs connecting said cane portion and the top of said electromotive device.

17. The device as in claim 14 wherein said extension spring assembly comprises a flat plastic spring connecting said cane portion and the top of said electromotive device.

18. The device as in claim 14 wherein said extension spring assembly comprises a coil spring mounted between guide rails connecting said cane portion and the top of said electromotive device.

19. The device as in claim 14 wherein said extension spring assembly comprises a plastic shaft that has a flexible section connecting said cane portion and the top of said electromotive device.

20. An electronic walking assistance device, comprising:
a cane portion, having surfaces for holding against arms and/or hands of a user;
an electromotive device, which automatically creates motion to follow a movement of the user, enabling walking assistance without lifting the electromotive device off the ground;
a tactile joystick connection between the cane portion and the electromotive device, which translates forward and backwards motion by the user into a tilting action against the electromotive device that causes forward or backward movement of the electromotive device, and where the tactile joystick connection allows side to side movement of 10 degrees without translating that into movement of the electromotive device;
said cane portion ends at an extension spring assembly which allows the side-to-side movement of up to 20 degrees, with 10 degrees of movement on each side.
said cane portion comprises at its lower end a single axis hinge connecting the cane portion to the top of the electromotive device allowing the single degree of freedom side to side movement of said cane portion relative to said electromotive device;
said electromotive device comprises a battery powered, electromotive self-leveling device;
said extension spring assembly comprises a first spring between a left side of the second end of the cane and a second spring on the right side of the second end of the cane and the movement device, which allows flexing of the cane in the side-to-side direction, but does not allow flexing of the cane relative to the top surface of the movement device in the front to back direction;
said cane portion comprises a switch located in the handle near a hand of the user;
said cane portion further comprises an adjustable height and a wire, which extends from the switch to the movement device, wherein the wire is coiled in an area of a height adjustment.
